(19) United States
(12) Patent Application Publication
(10) Pub. No.: US 2006/0165230 A1
(43) Pub. Date: Jul. 27, 2006

(54) Holder for portable communications devices and associated methods

(76) Inventor: Marie T. Parr, Deland, FL (US)

Correspondence Address: MICHAEL W. TAYLOR, ESQUIRE;ALLEN, DYER, DOPPELT, MILBRATH & GILCHRIST, P.A., P.O. Box 3791, Orlando, FL, 32802-3791, US

(21) Appl. No.: 11/332,987

(22) Filed: Jan. 17, 2006

Related U.S. Application Data
(60) Provisional application No. 60/645,686, filed on Jan. 21, 2005.

(51) Int. Cl. H04M 1/00

(52) U.S. Cl. 379/454; 379/455

(57) ABSTRACT

A holder for a portable communications device is in the shape of a shoe, and includes a base defining a sole of the shoe, and an upper connected to the base. The upper includes a heel section having an opening therein for receiving a lower portion of the portable communications device. The heel section includes an inner backing exposed by the opening so that a front side of the portable communications device rests thereagainst when received by the opening. A toe section is adjacent to and extends in height above the heel section so that a back side of an upper portion of the portable communications device rests thereagainst at a desired angle when the lower portion thereof is in the opening of the heel section.

### RELATED APPLICATION

This application claims the benefit of U.S. Provisional Application Ser. No. 60/645,686 filed Jan. 21, 2005, the entire contents of which are incorporated herein by reference.

### FIELD OF THE INVENTION

The present invention relates to the field of portable communications devices, such as cell phones and cordless handsets, and more particularly, to a holder for a portable communications device that allows a user to operate such a device when being held in place by the holder.

### BACKGROUND OF THE INVENTION

There are numerous holders currently available for portable communications devices. Many of these holders are designed for a flat surface, and hold a cell phone or cordless handset in an upright position. For example, U.S. Design Pat. Nos. D480,376 and D468,305 each illustrate a holder for receiving such a portable communications device.

In each case, a lower potion of the portable communications device is held by the holder. The upper portion of the portable communications device is held away from the holder to allow easy removal by a user. However, if the user desires to operate the portable communications device while remaining in the holder, the device has a tendency to become dislodged. This is particularly true when the user is physically impaired.

In addition, many of the holders are intended for particular style cell phones or cordless handsets since they are also being charged when being held in place by the holder. Consequently, this limits the adaptability of a holder to accommodate different size portable communications devices.

### SUMMARY OF THE INVENTION

In view of the foregoing background, it is therefore an object of the present invention to provide a holder for a portable communications device that allows a user to operate the device while being held in place by the holder.

Another object of the present invention is to provide a holder for a portable communications device that can accommodate different size devices.

These and other objects, features and advantages in accordance with the present invention are provided by a holder for a portable communications device in the shape of a shoe, and comprising a base defining a sole of the shoe, and an upper connected to the base. The upper comprises a heel section and a toe section adjacent thereto.

The heel section has an opening therein for receiving a lower portion of the portable communications device. The heel section may comprise an inner backing exposed by the opening so that a front side of the portable communications device rests thereagainst when received by the opening. The toe section extends in height above the heel section so that a back side of an upper portion of the portable communications device rests thereagainst at a desired angle when the lower portion thereof is in the opening of the heel section.

The portable communications device may be a cell phone or a cordless handset, for example. Such a device is held in place at the desired angle by the holder, and this allows the user to make or receive a telephone call without having to remove the device from the holder. For physically a physically impaired user, this is particularly beneficial, especially when using the device in a hands-free mode.

The opening in the heel section may have a V-shaped opening that increases in width towards the toe section. The heel section may comprise a resilient material to accommodate different size portable communications devices. An outer layer, such as a cloth material, may enclose the resilient material.

The holder may further comprise a see-through protective shield that extends across at least a portion of the opening in the heel section for protecting a keypad of the portable communications device when placed therein. If there is moisture or dirt on the user's hands, for example, the protective shield prevents such contact with the keypad.

The inner backing in the heel section may include an opening extending therethrough that is aligned with a microphone in the portable communications device. This advantageously allows the user to speak more clearly into the microphone when the portable communications device is in the holder.

The toe section may be spherically shaped and may comprise a pliable material layer, such as plastic, for example. The pliable material layer may be see-through. The toe section may be hollow, and may include an opening through the pliable material layer for receiving a weighted material. The weighted material maybe liquid, gel, beads or beans, for example. The toe section provides a stable surface for the upper portion of the portable communications device.

The base may comprise a non-skid bottom to prevent the holder from sliding around on a flat surface. In addition, an elastic band may be stretched around the toe section for holding in place a pen or pencil, for example.

Another aspect of the invention is directed to a method for holding a portable communications device using a holder in the shape of a shoe as defined above. The method may comprise positioning a lower portion of the portable communications device into an opening in the heel section. The heel section may comprise an inner backing exposed by the opening so that a keypad side of the portable communications rests thereagainst when positioned in the opening. The method may further comprise positioning a back side of an upper portion of the portable communications device against the toe section that is adjacent to and extends in height above the heel section. This is done so that the portable communications device is at a desired angle when the lower portion thereof is in the opening of the heel section.

### BRIEF DESCRIPTION OF THE DRAWINGS

FIG. 1 is a front perspective view of a holder for a portable communications device in accordance with the present invention.

FIG. 2 is a front view of the holder illustrated in FIG. 1 holding a portable communications device.

FIG. 3 is a side view of the holder illustrated in FIG. 1 holding a portable communications device.

FIG. 4 is a cut-away side view of the holder illustrated in FIG. 1.

FIG. 5 is a side view of the holder illustrated in FIG. 1 with an elastic band around the toe section for holding a pencil.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

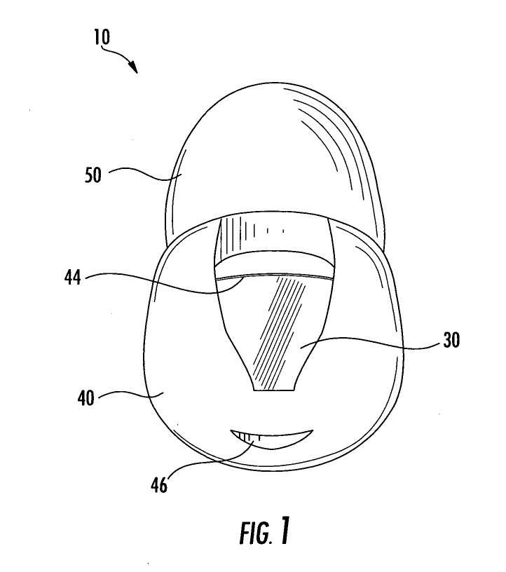

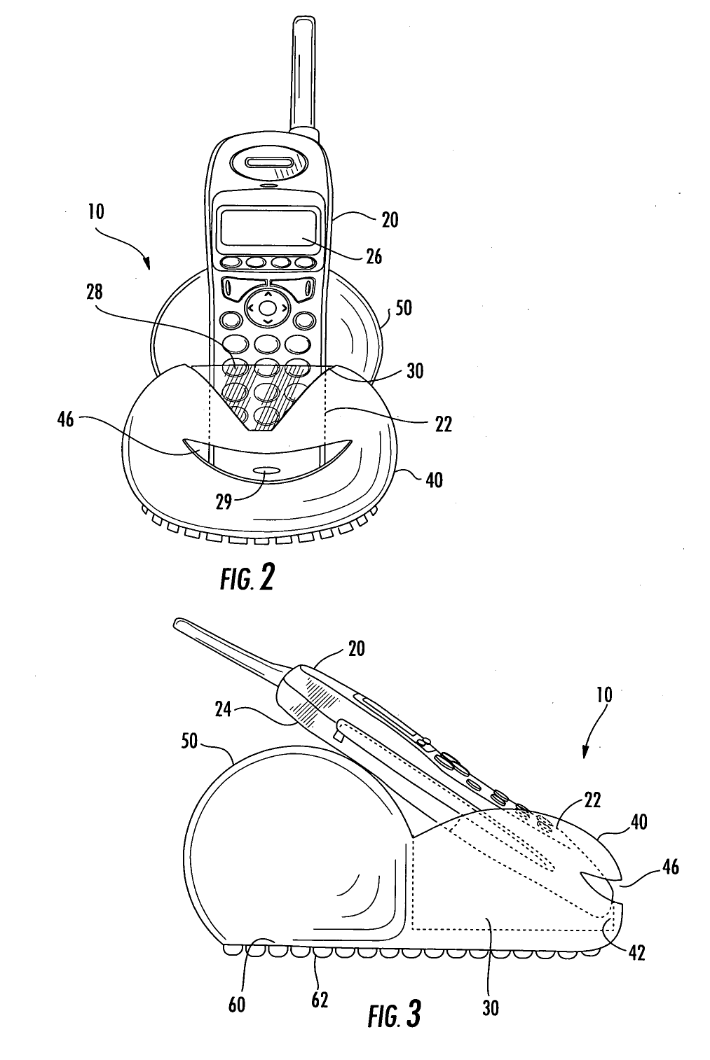

Referring initially to FIGS. 1-4, a holder 10 for a portable communications device 20 is in the shape of a shoe. As noted above, the portable communications device 20 may be a cell phone or a cordless handset, for example. For purposes of discussing the invention, the portable communications device 20 will be referred to as a cell phone. The holder 10 may be positioned on flat surfaces, such as countertops, desktops or tabletops, for example, for holding a cell phone 20. Alternatively, the holder 10 may be placed on the dash or console in an automobile, for example.

An advantage of the holder 10 is that it allows a user to receive or place a call while the cell phone 20 is still in the holder, and without the cell phone becoming dislodged from the holder while in use. As will be discussed in greater detail below, a lower portion 22 of the cell phone 20 is held in place by an opening 30 in a heel section 40 of the shoe-shaped holder 10, and an upper portion of the cell phone rests on a toe section 50 of the holder that is adjacent the heel section.

More particularly, the holder 10 comprises a base 60 defining a sole of the shoe, and an upper connected to the base. The upper includes the heel section 40 and the toe section 50. The heel section 40 has the opening 30 therein for receiving the lower portion 22 of the cell phone 20. The heel section 40 comprises an inner backing 42 exposed by the opening 30 so that a front side of the cell phone 20 rests thereagainst when received by the opening.

The toe section 50 is adjacent to and extends in height above the heel section 40 so that a backside of the upper portion 24 of the cell phone 20 rests thereagainst at a desired angle. The desired angle is such that the display 26 of the cell phone 20 can be easily read by the user when viewing the cell phone. An example height of the heel section 40 is within a range of 1 to 3 inches, and an example height of the toe section 50 is within a range of 2 to 4 inches.

A width of the V-shaped opening 30 in the heel section 40 may extend about 2 inches in length across at the top of the V, whereas a height of the V-shaped opening may extend about 2.5 inches in length, for example. An overall length of the older 10 is about 6 to 10 inches, and an overall width is about 3 to 6 inches, for example.

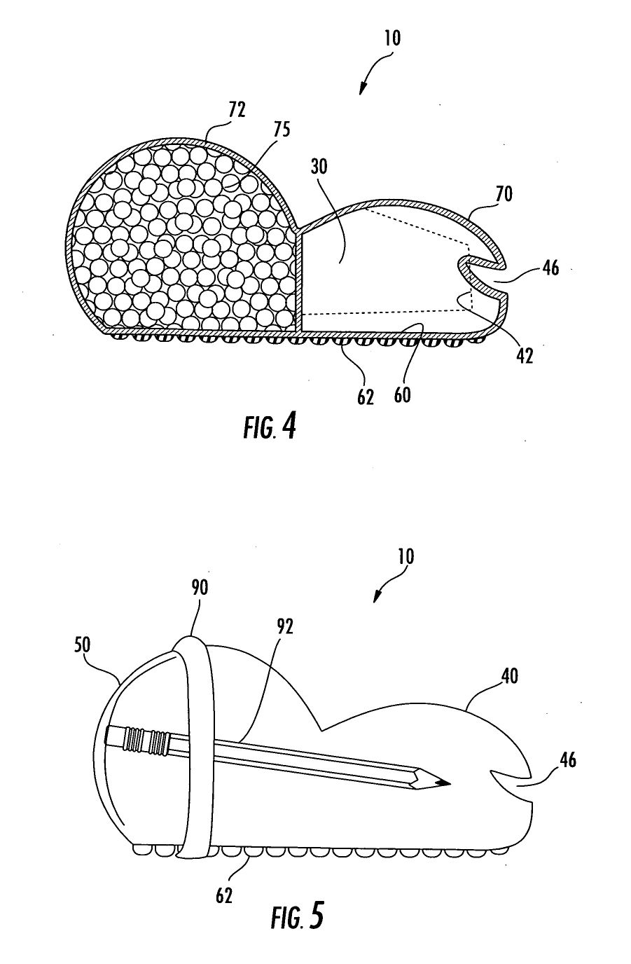

The opening 30 in the heel section has a V-shape that increases in width towards the toe section 50. For the holder 10 to be compatible with different size cell phones, the heel section 40 comprises a resilient material, such as foam or rubber, for example, or another type of pliable material. The resilient material may be decorated as is, or may be covered with an outer layer 70 of a protective and/or decorative material, as best shown in FIG. 4. The material may be cloth, for example.

At least an upper portion of the side edges of the V-shape opening 30 can expand as the cell phone 20 is inserted therethrough. As a result, pressure is applied to the lower portion 22 of the cell phone 20. In addition, although not shown in the drawings, at least a lower portion of the side edges of the V-shape opening 30 can include side cavities or ankle bone areas within the heel section 40 to serve as storage areas for small items, such as loose change, for example.

The holder 10 further comprises a see-through protective shield 44 that extends across at least a portion of the opening 30 in the heel section 40 for protecting the keypad 28 of the cell phone 20. The keys on the keypad 28 are protected from moisture or dirt that may be on the user's hand. For example, the user is in the kitchen preparing dinner, and the cell phone 20 rings. The user can immediately answer the cell phone 20 while it is being held in place by the holder 10 without first having to wash their hands. Afterwards, the user simply wipes the clear protective shield 44 if necessary.

The protective shield 44 may be secured in the heel section 40 via a hoop and loop fastener, such as Velcro™, for example. Other methods for securing the protective shield 44 include glue and double sided tape, for example. Since the protective shield 44 may be easily removed, it can be easily cleaned, and if necessary, replaced with a new protective shield.

The inner backing 42 in the heel section 40 includes an opening 46 extending therethrough that is aligned with an audio transducer 29, i.e., a microphone, in the cell phone 20. The opening 46 may be in the shape of a smiley face, for example, and provides a relatively unrestricted passageway for the microphone 29 so that the user's voice is not too muffled when they speak.

The toe section 50 is spherically shaped and comprises a pliable material layer 72, as best illustrated in FIG. 4. The toe section 50 is hollow, and the pliable material layer 72 provides the spherical shape. The pliable material layer 72 includes an opening (not shown) therein for receiving a weighted material. The weighted material may be beads so that the toe section 50 essentially forms a bean bag, as shown in FIG. 4. In lieu of beads, actual beans may be used.

The pliable material layer 72 may be a see-through material, such as the plastic commonly used in water bottles. In this case, the weighted material may be a liquid or gel, for example. The opening in the pliable material layer 72 is closed or plugged when the weighted material is in the toe section 50. Suspended within the liquid or gel may be decorative items, which are visible through the pliable material layer 72. The toe section 50 may also be configured to include a scenic display, and by shaking the toe section, small suspended particles representing snow, for example, could circulate around the scenic display.

In another embodiment, an output protective layer may cover the pliable material layer 72. This outer protective layer (not shown), as well as the outer protective layer 72 for the heel section 40, may be made out of fabric, for example. The fabric may even be bright in color and/or include a decorative design so that the holder 10 can be easily noticed in a room. Since the heel and toe sections 40, 50 are not a hardened plastic, it is more accommodating to receiving different size cell phones.

To prevent the holder 10 from sliding around when on a surface, the base 60 comprises a non-skid bottom 62. The non-skid bottom 62 may be made out of rubber, for example. The holder 10 may further comprises an elastic band 90 positioned around the toe section 50 for holding a writing instrument 92. The writing instrument 92 maybe a pen or pencil, for example. The elastic band 90 may be a hair band, for example.

Another aspect of the invention is directed to a method for holding the cell phone 10 using the holder 20 as defined above. The method comprises positioning the lower portion 22 of the cell phone 20 into the opening 30 in the heel section 40. The heel section 40 comprises an inner backing 42 exposed by the opening 30 so that the keypad side of the cell phone 20 rests thereagainst when positioned in the opening. The method further comprises positioning the backside of the upper portion 24 of the cell phone 20 against the toe section 50 that extends in height above the heel section 40 so that the cell phone 20 is at a desired angle.

Many modifications and other embodiments of the invention will come to the mind of one skilled in the art having the benefit of the teachings presented in the foregoing descriptions and the associated drawings. For instance, portable communications devices are not limited to cell phones and cordless handsets. Portable communications devices may include IPODs, MP3 players and Sony walkmans, for example. Therefore, it is understood that the invention is not to be limited to the specific embodiments disclosed, and that modifications and embodiments are intended to be included within the scope of the appended claims.

That which is claimed is:

1. A holder for a portable communications device in the shape of a shoe, and comprising:
a base defining a sole of the shoe; and
an upper connected to said base and comprising
a heel section having an opening therein for receiving a lower portion of the portable communications device, said heel section comprising an inner backing exposed by the opening so that a front side of the portable communications device rests thereagainst when received by the opening, and
a toe section adjacent to and extending in height above said heel section so that a back side of an upper portion of the portable communications device rests thereagainst at a desired angle when the lower portion thereof is in the opening of said heel section.

2. A holder according to claim 1 wherein the opening in said heel section has a V-shaped opening that increases in width towards said toe section.

3. A holder according to claim 1 wherein said heel section comprises a resilient material to accommodate different size portable communications devices.

4. A holder according to claim 3 wherein said heel section further comprises an outer layer enclosing the resilient material.

5. A holder according to claim 1 further comprising a see-through protective shield that extends across at least a portion of the opening in said heel section for protecting a keypad of the portable communications device when placed therein.

6. A holder according to claim 1 wherein the inner backing in said heel section includes an opening extending therethrough that is aligned with an audio transducer in the portable communications device.

7. A holder according to claim 1 wherein said toe section is spherically shaped and comprises a pliable material layer defining the spherical shape.

8. A holder according to claim 7 wherein the pliable material layer is see-through.

9. A holder according to claim 7 wherein said toe section is hollow, and includes an opening through the pliable material layer for receiving a weighted material.

10. A holder according to claim 9 wherein the weighted material comprises at least one of liquid, gel, beads and beans.

11. A holder according to claim 1 wherein said base comprises a non-skid bottom.

12. A holder according to claim 1 further comprising an elastic band to be stretched around said toe section for holding in place a writing instrument.

13. A holder according to claim 1 wherein the portable communications device comprises at least one of a cell phone and a cordless handset.

14. A method for holding a portable communications device using a holder in the shape of a shoe, the holder comprising a base defining a sole of the shoe, and an upper connected to the base and comprising a heel section and a toe section, the method comprising:
positioning a lower portion of the portable communications device into an opening in the heel section, the heel section comprising an inner backing exposed by the opening so that a keypad side of the portable communications device rests thereagainst when positioned in the opening; and
positioning a back side of an upper portion of the portable communications device against the toe section that is adjacent to and extends in height above the heel section so that the portable communications device is at a desired angle when the lower portion thereof is in the opening of said heel section.

15. A method according to claim 14 wherein the opening in the heel section has a V-shaped opening that increases in width towards the toe section.

16. A method according to claim 14 wherein the heel section comprises a resilient material to accommodate different size portable communications devices.

17. A method according to claim 14 wherein the holder further comprises a see-through protective shield that extends across at least a portion of the opening in the heel section for protecting a keypad of the portable communications device.

18. A method according to claim 14 wherein the inner backing in the heel section includes an opening extending therethrough that is aligned with an audio transducer in the portable communications device.

19. A method according to claim 14 wherein the toe section is spherically shaped and comprises a pliable material layer defining the spherical shape.

20. A method according to claim 19 wherein the pliable material layer is see-through.

21. A method according to claim 19 wherein the toe section is hollow, and includes an opening therein the pliable material layer for receiving a weighted material.

22. A method according to claim 21 wherein the weighted material comprises at least one of liquid, gel, beads and beans.

23. A method according to claim 14 wherein the base of the portable communications device comprises a non-skid bottom.

24. A method according to claim 14 wherein the portable communications device comprises at least one of a cell phone and a cordless handset.
